(19) United States
(12) Patent Application Publication
(10) Pub. No.: US 2011/0032027 A1
(43) Pub. Date: Feb. 10, 2011

(54) SWITCHED BANDGAP REFERENCE CIRCUIT FOR RETENTION MODE

(75) Inventors: Ranjit Kumar Dash, Chennai (IN); Eran Nussbaum, Herzlia (IL); Supraja Krishnan, Chennai (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/536,350

(22) Filed: Aug. 5, 2009

(51) Int. Cl. G05F 1/10

(52) U.S. Cl. 327/539

(57) ABSTRACT

A low power bandgap reference circuit for retention mode in system on chips (SoCs). A switched bandgap reference includes bandgap reference circuit coupled to a storage capacitor through a switch. A logic having a set of control signals controls the switch and the bandgap reference circuit such that during a retention mode the bandgap reference circuit and the switch are active for a first time interval in response to the set of control signals to recharge the storage capacitor and then inactive for a second time interval in response to the set of control signals that decouples the bandgap reference circuit from the storage capacitor. The charge stored in the storage capacitor is used to generate a reference voltage.

### TECHNICAL FIELD

Embodiments of the disclosure relate to bandgap reference circuits.

### BACKGROUND

In communication applications, for example a mobile application, a device spends its life time in retention mode or deep sleep mode. It is expected that the device consumes as less power as possible during these modes. Voltage regulators and bandgap reference circuits in the device consumes a significant part of this power to generate the supply for a retention logic.

There are several approaches to reduce power consumption of the bandgap reference circuits. One such approach is to employ two bandgap reference circuits, one regular bandgap reference circuit for active mode and another low power bandgap reference circuit for retention mode. This approach is area inefficient because of the two separate bandgap reference circuit designs. Further, switching between two bandgap reference circuits may produce an output voltage glitch as they could be at different voltages at a given temperature. Another conventional approach is to use a common bandgap reference circuit for active mode and retention mode of the device. However, in this approach, the bandgap reference circuit needs to be accurate to support expected voltage accuracy in the active mode. For higher accuracy, the bandgap reference circuit requires more power. In conclusion these conventional approaches of designing low current bandgap reference circuits become unattractive in terms of design complexity, area and accuracy.

### SUMMARY

An exemplary embodiment provides a low power system in retention mode. The system includes a bandgap reference circuit coupled to a storage capacitor through a switch. The system further includes a logic having a set of control signals that controls the switch and the bandgap reference circuit such that during a retention mode the bandgap reference circuit and the switch are active for a first time interval in response to the control signals to recharge the storage capacitor, and then inactive for a second time interval in response to the control signals that decouples the bandgap reference circuit from the storage capacitor. When the bandgap reference circuit is decoupled, charge stored in the storage capacitor is used to generate a reference voltage.

An exemplary embodiment provides an integrated circuit (IC). The integrated circuit includes a bandgap reference circuit that generates a reference voltage, coupled to a storage capacitor through a switch. The IC further includes a logic having a bandgap enable signal that controls the bandgap reference circuit and a refresh enable signal that controls the switch such that, during an active mode the bandgap reference circuit is active in response to the bandgap enable signal and the switch is active in response to the refresh enable signal signal. During a retention mode the, bandgap reference circuit and the switch are active for a first time interval in response to the bandgap enable signal and the refresh enable signal respectively, and then the switch and the bandgap reference circuit are inactive for a second time interval in response to the refresh enable signal and the bandgap enable signal respectively that decouples the bandgap reference circuit from the storage capacitor. When the bandgap reference circuit is decoupled, charge stored in the storage capacitor is used to generate a reference voltage. The IC further includes a regulator coupled to the storage capacitor that receives the reference voltage.

An exemplary embodiment provides a method for operating a bandgap reference circuit when a device is in an active mode and a retention mode. The bandgap reference circuit is coupled to a storage capacitor during an active mode. During the retention mode, the bandgap reference circuit is coupled to the storage capacitor for a first time interval and then decoupled from the storage capacitor for a second time interval. Further, charge stored in the storage capacitor is used for generating the reference voltage for the regulator during the retention mode.

Other aspects and example embodiments are provided in the Drawings and the Detailed Description that follows.

### BRIEF DESCRIPTION OF THE VIEWS OF DRAWINGS

FIG. 1 illustrates a switched bandgap reference circuit according to an embodiment;

FIG. 2A illustrates a low drop-out (LDO) regulator with a switched bandgap reference circuit according to another embodiment;

FIG. 2B illustrates an LDO regulator with a switched bandgap reference circuit according to another embodiment;

FIG. 3 illustrates timing requirements of the bandgap reference circuit and a switch of FIG. 2A and FIG. 2B.

FIG. 4 is a graph illustrating quiescent current and accuracy calculation of the switched bandgap reference circuit according to an embodiment;

FIG. 5 is a flow diagram illustrating a method for operating a bandgap reference circuit in a retention mode according to an embodiment; and

FIG. 6 is a block diagram illustrating a mobile communication device using the LDO regulator that includes the switched bandgap reference circuit of FIG. 2A and FIG. 2B.

### DETAILED DESCRIPTION OF THE EMBODIMENTS

Low drop-out (LDO) regulators are special type of regulators where the minimum voltage required between the input and the output (the drop out voltage) is particularly low. This allows a battery to continue to power the LDO regulator almost until the battery voltage drops to the level of the desired output. LDO regulators are thus used to provide a stable voltage source for the other circuitry in the device, for example in a mobile communication device, the processors, memory, input or output and other peripherals.

One embodiment provides a switched bandgap reference circuit that minimizes retention mode current in system on chips (SoCs). Another embodiment provides a low drop-out (LDO) regulator with a switched bandgap reference circuit that minimizes retention mode current. Another embodiment provides a method for operating a bandgap reference circuit in a retention mode.

Various embodiments are explained using a mobile communication device as an example. However, it will be appreciated that various embodiments may find an application in various wireless communication systems including battery less systems such as radio frequency identification (RFID) tags that need very low power. In general embodiments can be used in any application where power harvesting is required such as power harvesting schemes or very low power sensors.

In various embodiments, an active mode is a mode when there is processor activity and most of the device's functions are in active state. In various embodiments, a retention mode is a mode when there is no processor activity and most of the device's functions are in idle state.

It is noted that in the retention mode, the current sink from the power supply is not used for the device's activities, but is lost in the LDO regulator's biasing current. Accordingly, the current consumption of the LDO regulator during the idle states has a significant effect on the device's battery life.

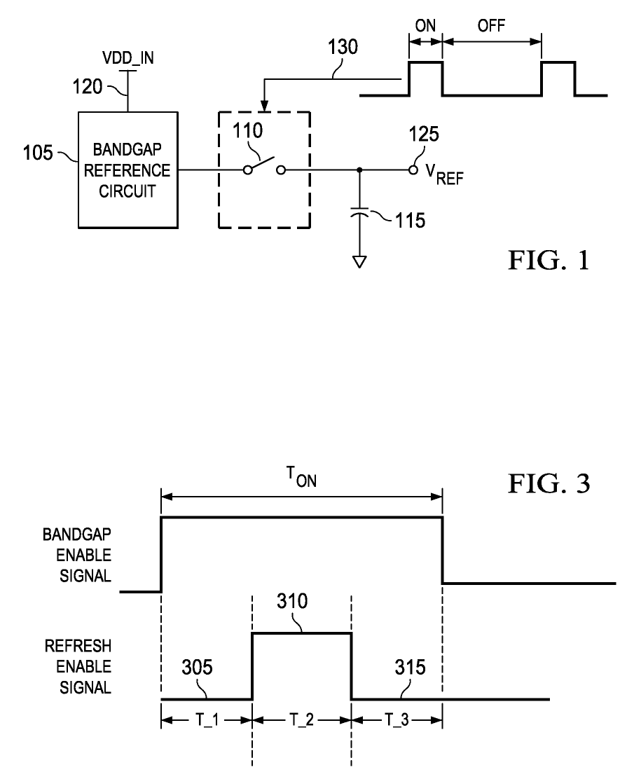

Embodiments are best understood in relation to FIGS. 1-6 of the drawings, like numerals being used for like elements of the various drawings.

FIG. 1 a switched bandgap reference circuit. The circuit includes a bandgap reference circuit 105. An output of the bandgap reference circuit 105 is connected to a switch 110. A supply voltage VDD_IN is supplied to the bandgap reference circuit 105 on a line 120. An input control signal is connected to the switch on a line 130. The switch 110 is connected to a storage capacitor 115. An output of the bandgap reference circuit (reference voltage V_{REF}) is taken across the storage capacitor from a line 125.

The switch 110 is implemented as a low leakage switch. During an active mode the bandgap reference circuit 105 and the switch 110 is in active state (ON) and the output of the bandgap reference circuit 105 is taken across the storage capacitor 115. During retention mode, the switch 110 is deactivated using the control signal. This will store charge in the storage capacitor 115 which can be used for generating V_{REF} in the retention mode. However, due to the leakage property of a capacitor, charge stored in the storage capacitor 115 will eventually drain off over a period of time which results in a dip in the V_{REF} taken from the storage capacitor 115. Additionally, the storage capacitor 115 will have a high resistance associated in parallel with it. This high resistance also contributes to charge leakage. To address the leakage, according to an embodiment, the bandgap reference circuit 105 and the switch 110 connecting to the storage capacitor 115 is activated for a very short interval (for example, an interval between 200 μs to 15 ms) to recharge the storage capacitor 115. Once the storage capacitor 115 is recharged to a required level, the bandgap reference circuit 105 and the switch 110 are inactivated for an interval (for example, an interval between 10 ms to 15 ms). Further, charge stored in the storage capacitor 115 is used to generate the V_{REF}.

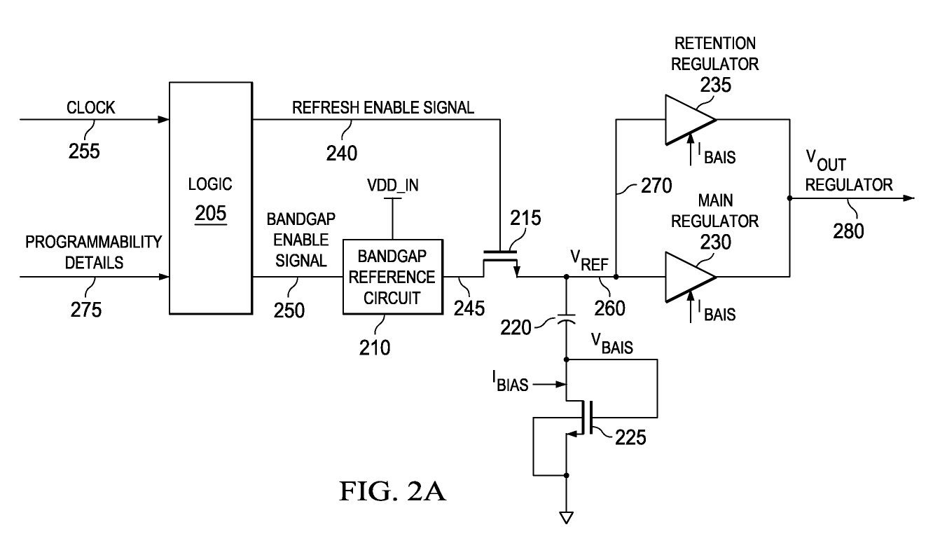

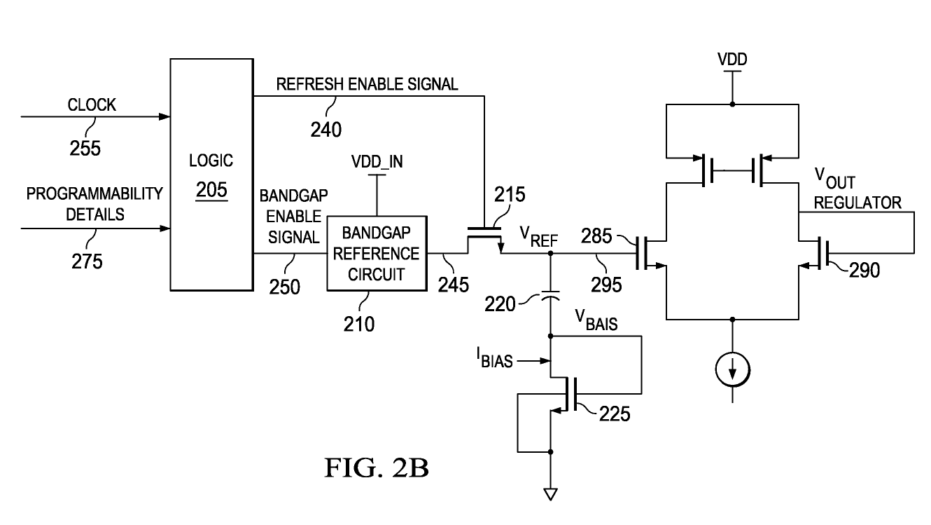

For the sake of simplicity, only the bandgap reference circuit 105 and the switch 110 are illustrated in FIG. 1. Implementations of the switch bandgap reference circuits in LDO regulators, according to various embodiments, are explained in conjunction with FIG. 2A and FIG. 2B.

FIG. 2A illustrates an LDO regulator with a switched bandgap reference circuit. The LDO regulator includes a bandgap reference circuit 210, a logic 205, a switch (transistor) 215, a storage capacitor 220, a transistor 255, a main regulator 230 and a retention regulator 235.

The logic 205 includes a counter and a plurality of control registers (not shown in FIG. 2A). The counter receives a clock signal on a line 255. The control registers receive programmability details on a line 275. Outputs of the logic 205 include two control signals namely refresh enable signal 240 and bandgap enable signal 250. The bandgap reference circuit 210 receives the bandgap enable signal 250 and the switch 215 receives the refresh enable signal 240. A supply voltage VDD_IN is supplied to the bandgap reference circuit 210. The switch (215) includes an NMOS transistor 215, hereinafter referred to as transistor 215 or switch 215 interchangeably. A gate of the transistor 215 receives the refresh enable signal. A drain of the transistor 215 is connected to the bandgap reference circuit 210 on a line 245 and a source is connected to the storage capacitor 220. The storage capacitor 220 is connected to a drain of another NMOS transistor 225. The transistor 225 is implemented as a gate source coupled (diode) transistor. The transistor 225 receives a bias current (I_{BIAS}) on the drain. The storage capacitor 220 is further connected to the main regulator 230 on a line 260 and to the retention regulator 235 on a line 270. The main regulator 230 and retention regulator 235 receives reference voltage (V_{REF}) on lines 260 and 270 respectively. The main regulator 230 and the retention regulator 235 receive bias current (I_{BIAS}). An output of the regulators (V_{OUT}_{_{—}}_{REGULATOR}) is taken on a line 280.

During the active mode the bandgap reference circuit 210 and the switch 215 are activated (ON state) using the bandgap enable signal 250 and the refresh enable signal 240 respectively. The output of the bandgap reference circuit 210 is taken across the storage capacitor 220. During the retention mode, the bandgap reference circuit 210 is activated using the bandgap enable signal 250. Bandgap reference circuit 210 requires some time to settle. After the bandgap reference circuit 210 is settled, the switch 215 is activated using the refresh enable signal 240. Since the switch 215 is connected to the storage capacitor 220, the storage capacitor 220 is recharged to a required level. In other words, charge in the storage capacitor 220 is refreshed from the bandgap reference voltage. Also, a low pass filter formed by the switch ON resistance and the storage capacitor 220 is used to filter output noise. In one embodiment, the bandgap reference circuit 210 and the switch 215 is activated only for a short time interval. The time interval may be programmed into the logic 205. Upon refreshing the charge in the storage capacitor 220, the switch 215 is inactivated using the refresh enable signal (240). Inactivating the switch 215 isolates the storage capacitor 220 from the bandgap reference circuit 210. Then, the bandgap reference circuit 210 is inactivated using the bandgap enable signal (250).

To minimize current consumption of the LDO regulator during retention mode, the time interval when the bandgap reference circuit 210 and the switch 215 is inactive (OFF time interval) needs to be maximized in comparison with the time interval when the bandgap reference circuit 210 and the switch 215 are active (ON time interval). OFF time interval is dependant on the leakage from the storage capacitor node. There are predominantly two leakage mechanisms that cause the charge stored in the storage capacitor 220 to decay. One leakage mechanism is the sub threshold leakage through the switch 215. When the switch 215 is inactivated, one side of the switch 215 is connected to the reference voltage and another side to the output of the bandgap reference circuit 210. Since the output of the bandgap reference circuit 210 is zero volts, a potential difference can be seen across the switch 215. This potential difference causes the sub threshold leakage. To overcome the sub threshold leakage, in one embodiment, a transistor with large length is implemented as the switch 215 so that the sub threshold leakage is minimum.

Second leakage mechanism may be caused due to gate tunneling through the storage capacitor 220. In the CMOS processes, the storage capacitor 220 used is an NPOLY NWELL capacitor that includes a poly gate connection, wherein charge is held by the gate oxide capacitance. In deep submicron processes, the gate oxide thickness is very less. If the gate oxide thickness is very less, due to tunneling, conduction may occur through the gate oxide itself. Tunneling is directly proportional to the electrical field strength. So, more the voltage across the gate oxide, more the gate tunneling and leakage. To minimize the gate tunneling, bottom plate of the storage capacitor 220 is biased at an appropriate voltage by the transistor (diode) 225 and current source I_{BIAS}. Current (very small amount of current) is pumped into the diode 225 and bias voltage V_{BIAS} is generated that biases the bottom plate of the storage capacitor 220.

The bandgap enable signal 250 and refresh enable signal 240 (control signals) are generated from the logic 205 using a digital controller running out of a slow clock, for example a 32 Kh clock. The programmability and timing details of the refresh enable signal 240 and bandgap enable signal 250 are explained in conjunction with FIG. 3. Programmability is built in the logic to change the timing post silicon to address any process variations.

FIG. 2B illustrates the LDO regulator along with the input pair of the regulator that receives the reference voltage (V_{REF}) from the storage capacitor 220. In one embodiment, the retention regulator 235 includes an input pair of NMOS transistors 285 and 290. Input pair may be realized also using PMOS transistors in another embodiment. Sources of the transistors 285 and 290 are coupled to each other and further to the ground voltage. A gate of the transistor 285 receives V_{REF} on a line 295. Output voltage of the regulator (V_{OUT}_{_{—}}_{REGULATOR}) is taken out from a node between the drain and gate of the transistor 290. In one embodiment, the input pair of transistors 285 and 290 are implemented as thick oxide transistors (for example 1.8 v gate-oxide transistors) to minimize gate leakage current. Operation of the LDO regulator illustrated in FIG. 2B is same as the LDO regulator illustrated in FIG. 2A.

FIG. 3 illustrates timing requirements of bandgap reference circuit 210 and the switch 215. Specifically, timing diagrams of the bandgap enable signal (250) and refresh enable signal (240) that controls the bandgap reference circuit (210) and the switch (215) is illustrated in FIG. 3. When bandgap enable signal 250 is activated (T_{ON}), the bandgap reference circuit 210 is activated. After activation, the refresh enable signal 240 is activated after a time period of T1, 305 to ensure that the bandgap reference circuit 210 is settled within required accuracy. The refresh enable signal 240 is active for a time period of T2, 310 to ensure that the storage capacitor 220 is refreshed to a required charge level. Further, the refresh enable signal 240 is inactivated for a time period of T3, 315 to ensure that the storage capacitor 220 is completely isolated before the bandgap reference circuit 210 is inactivated to prevent any loss of stored charge through the bandgap reference circuit 210. As explained earlier, to minimize current consumption of the LDO regulator during retention mode, the time interval when the bandgap reference circuit 210 and the switch 215 is inactive (OFF time interval) needs to be maximized in comparison with the time interval when the bandgap reference circuit 210 and the switch 215 are active (ON time interval). In one example implementation, the T_{ON} time interval is selected from a range of 200 μs to 15 ms and the T_{OFF} time interval is selected from a range of 10 ms to 15 ms. The nominal T_{ON}/T_{OFF will} be equal to 300 μs/12000 μs.

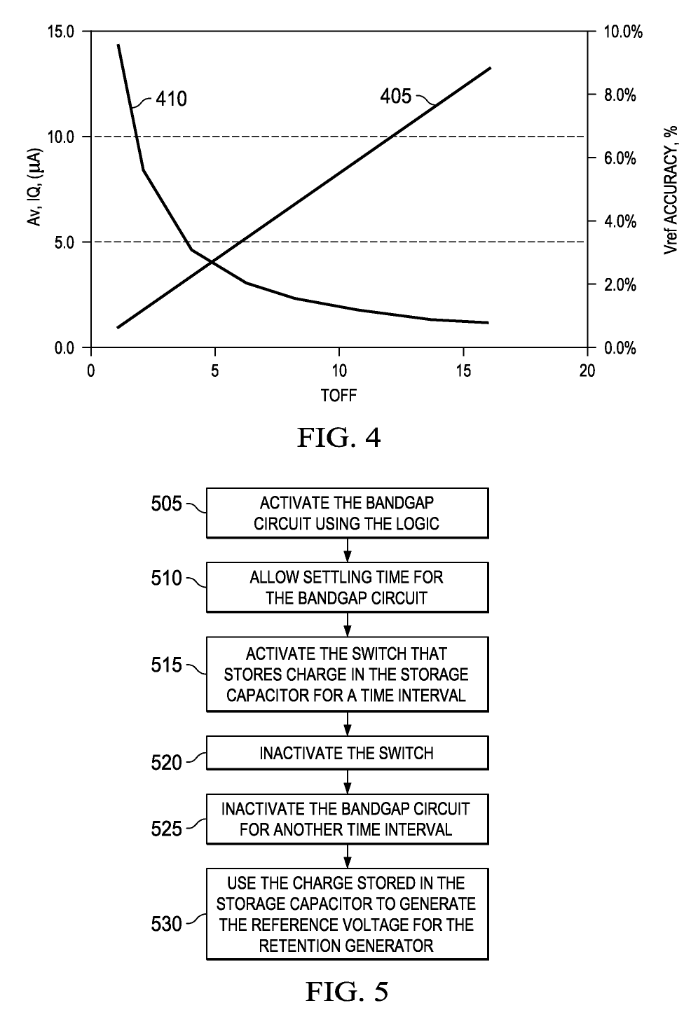

FIG. 4 is a graph illustrating quiescent current and accuracy calculation of the switched bandgap reference circuit 210 according to an embodiment. Average quiescent current is calculated using the formula

$$\begin{matrix}{I}_{Q , AV} = {I}_{Q , BG} * {T}_{ON /} ( {T}_{ON} + {T}_{OFF )} \\ = {I}_{Q , BG} * D ,\end{matrix}$$

Wherein I_{Q, AV} is the average quiescent current, I_{Q, BG} is the bandgap quiescent current, T_{ON} is the ON time interval of the bandgap reference circuit 210, T_{OFF} is the OFF time interval of the bandgap reference circuit 210 and D is the duty cycle of the refresh pulse.

Accuracy is calculated using the formula ΔV_{REF}=I_{LKG}*T_{OFF}/C_{STORAGE}
Wherein I_{LKG} is the leakage current and C_{STORAGE} is the capacitance value of the storage capacitor 220.

For calculating quiescent current and accuracy, values taken for various components included a storage capacitor of 60 pF, reference voltage of 600 mV, bandgap reference circuit quiescent current (I_{Q}) of 50 μA and leakage current, I_{LKG} of 0.2 nA at 600 mV, T_{OFF} of 15 ms and T_{ON} of 400 μs. Assuming these values the graph illustrates the trade off of average quiescent current to accuracy. From the above formula, it is noted that accuracy is defined as change in the reference voltage (ΔV_{REF}). Keeping T_{OFF} larger compared to T_{ON} helps to reduce the quiescent current, but decreases the accuracy which is acceptable in the applications where embodiments of the disclosure are used. Accuracy is plotted as a line 405 and quiescent current is plotted as a line 410.

FIG. 5 is a flow diagram illustrating a method for operating a bandgap reference circuit 210 in a retention mode according to an embodiment. As explained earlier, during the active mode, the bandgap reference circuit 210 is always active. During retention mode, at step 505, the bandgap reference circuit 210 is activated using the control signal, bandgap enable signal 250, from the logic 205. After activating, the bandgap reference circuit 210 is given some time to settle, at step 510. After the bandgap reference circuit 210 is settled, at step 515, the switch (transistor 215) is activated using the refresh enable signal 240 for a time interval (ON time interval or first time interval). Charge stored in the storage capacitor 220 is refreshed (storage capacitor 220 is recharged to a required level) during this time interval. Further, at step 520, the switch (215) is inactivated using the refresh enable signal 240. At step 525, the bandgap reference circuit 210 is inactivated using the bandgap enable signal 250 for another time interval (OFF time interval or second time interval). This decouples the bandgap reference circuit 210 from the storage capacitor 220. Further at step 530, charge stored in the storage capacitor 220 is used to generate the reference voltage V_{REF}. The ON time interval is very short compared to the OFF time interval. (ON time interval is selected from a range of 200 μs to 15 ms and the OFF time interval is selected from a range of 10 ms to 15 ms).

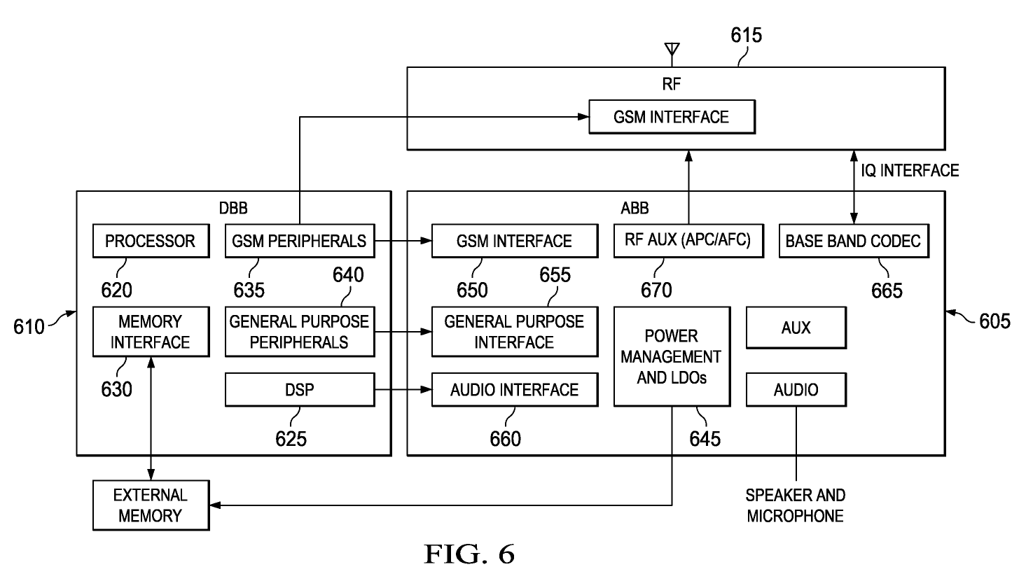

FIG. 6 is a block diagram illustrating a mobile communication device using the LDO regulator of FIG. 2A and FIG. 2B used in a mobile application. The mobile communication device includes an analog baseband chip (ABB, 605), a digital baseband chip (DBB, 610) and an RF chip 615. The RF chip 615 includes the modulation and demodulation circuitry and the GSM interface (for a GSM device). The digital baseband chip 610 includes one or mode multipurpose processors 620, one or more DSPs 625, a memory interface 630, GSM peripherals 635 and general purpose peripherals 640. The analog baseband chip 605 includes a power management and LDO regulator circuitry 645, including a plurality of LDO regulators (LDO regulators with switched bandgap reference circuit according to various embodiments, for example the switched bandgap reference circuit of FIG. 2A). The analog baseband chip 605 further includes a GSM interface 650 coupled to the GSM peripherals 635, a general purpose interface 655 coupled to the general purpose peripherals 640 and audio interface 660 coupled to the DSP 625, a baseband codec 665 coupled to the RF chip 615 and RF auxiliary circuit 670 coupled to the RF chip 615, and audio circuit coupled to the ear speaker and microphone, and an auxiliary circuit coupled to other external devices. While mobile communication device is shown as three distinct chips in the figure, improved fabrication techniques may allow functions of various chips to be integrated into one chip.

In the foregoing discussion, the term “connected” means at least either a direct electrical connection between the devices connected or an indirect connection through one or more passive or active intermediary devices. The term “circuit” means at least either a single component or a multiplicity of components, either active or passive, that are connected together to provide a desired function. The term “signal” means at least one current, voltage, charge, data, or other signal.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following Claims.

What is claimed is:

1. A system comprising:
a bandgap reference circuit coupled to a storage capacitor through a switch; and
a logic having a set of control signals that controls the switch and the bandgap reference circuit such that, during a retention mode the bandgap reference circuit and the switch are active for a first time interval in response to the set of control signals that recharges the storage capacitor, and then inactive for a second time interval in response to the set of control signals that decouples the bandgap reference circuit from the storage capacitor, charge stored in the storage capacitor being used to generate a reference voltage.

2. The system of claim 1 further comprising:
a diode and a current source that biases a bottom plate of the storage capacitor at an appropriate voltage to minimize gate tunneling leakage current through the capacitor.

3. The system of claim 2 further comprising:
a regulator coupled to the storage capacitor that receives the reference voltage.

4. The system of claim 1, wherein the logic controls the switch and the bandgap reference circuit such that during an active mode the switch and the bandgap reference circuit are active.

5. The system of claim 1, wherein the first time interval is very short compared to the second interval, and the switch and the bandgap reference circuit are active for the first time interval to ensure that the storage capacitor is charged to a required level.

6. The system of claim 1, wherein during the retention mode, the switch is inactivated prior to inactivating the bandgap reference circuit.

7. The system of claim 6, wherein the switch comprises a transistor.

8. The system of claim 5, wherein the storage capacitor comprises a NPOLY-NWELL capacitor.

9. The system of claim 7, wherein a length of the switch is designed to lower sub threshold leakage from the switch when the switch is OFF.

10. An integrated circuit comprising:
a bandgap reference circuit that generates a reference voltage, coupled to a storage capacitor through a switch;
a logic having a bandgap enable signal that controls the bandgap reference circuit and a refresh enable signal that controls the switch, such that:
during an active mode the bandgap reference circuit is active in response to the bandgap enable signal and the switch is active in response to the refresh enable signal; and
during a retention mode the bandgap reference circuit and the switch are active for a first time interval in response to the bandgap enable signal and the refresh enable signal respectively and then the switch and the bandgap reference circuit are inactive for a second time interval in response to the refresh enable signal and the bandgap enable signal respectively that decouples the bandgap reference circuit from the storage capacitor, thereby using the charge stored in the storage capacitor to generate a reference voltage; and
a regulator coupled to the storage capacitor that receives the reference voltage.

11. The integrated circuit of claim 10, wherein the regulator comprises at least one of a retention regulator and a main regulator.

12. The integrated circuit of claim 11, wherein the retention regulator and the main regulator are coupled in parallel.

13. The integrated circuit of claim 10, wherein the logic operates in response to a slow real time clock that minimizes power consumption in the integrated circuit.

14. The integrated circuit of claim 10 further comprising:
a diode and a current source to bias a bottom plate of the storage capacitor at an appropriate voltage to minimize gate tunneling through the capacitor.

15. A method of operating a bandgap reference circuit, the method comprising:
coupling the bandgap reference circuit to a storage capacitor during an active mode;
coupling the bandgap reference circuit to the storage capacitor for a first time interval during a retention mode;
decoupling the bandgap reference circuit from the storage capacitor for a second time interval; and
using the charge stored in the storage capacitor for generating the reference voltage for the regulator during the retention mode.

16. The method of claim 15, wherein coupling the bandgap to the storage capacitor for a first time interval comprises:
activating the bandgap reference circuit and a switch, using a control, that couples the bandgap reference circuit to the storage capacitor.

17. The method of claim 16, wherein decoupling the bandgap from the storage capacitor for a second time interval comprises:
inactivating the switch and the bandgap reference circuit, using a control from a logic, that decouples the bandgap reference circuit from the storage capacitor.

18. The method of claim 16, wherein activating the switch and the bandgap reference circuit for a first time interval comprising:
activating the bandgap reference circuit prior to activating the switch.

19. The method of claim 16, wherein activating the switch and the bandgap reference circuit for a first time interval comprising:
activating the bandgap reference circuit and the switch for a very short interval to recharge the capacitor.

20. The method of claim 17, wherein inactivating comprising:
inactivating the switch prior to deactivating the bandgap reference circuit.
